(19) United States
(12) Patent Application Publication
(10) Pub. No.: US 2026/0220947 A1
(43) Pub. Date: Jul. 30, 2026

(54) Method, Processing Device, System, and Computer Programme for Controlling a Vehicle Function

(71) Applicant: Bayerische Motoren Werke Aktiengesellschaft, Muenchen (DE)

(72) Inventors: Simone CAMBERG, Muenchen (DE); Thomas EWENDER, Bad Aibling (DE); Johannes FELDMAIER, Ebersberg (DE)

(21) Appl. No.: 19/145,571

(22) PCT Filed: Jan. 22, 2024
(86) PCT No.: PCT/EP2024/051421

§ 371 Date: Jul. 3, 2025

(30) Foreign Application Priority Data
Feb. 14, 2023 (DE) 10 2023 103 475.8

(51) Int. Cl. G06V 20/59; B60W 50/08; G06V 40/16; G06V 40/18; G10L 25/63

(52) U.S. Cl. CPC G06V 20/597; G06V 40/174; G06V 40/18; G10L 25/63; B60W 50/082; B60W 2540/21; B60W 2540/229

(57) ABSTRACT

A computer-implemented method for controlling a vehicle function of a vehicle is provided. The method includes: receiving conversation indicator information including indications of whether a driver of the vehicle is engaged in a telephone conversation, determining, based on the conversation indicator information, that the driver is engaged in a telephone conversation, receiving conversation intensity information including indications of how deeply the driver is engaged in the telephone conversation, determining an attention level of the driver towards the telephone conversation depending on the conversation intensity information, and generating a control signal for a vehicle function of the vehicle depending on the determined attention level.

### BACKGROUND AND SUMMARY

The invention relates to a computer-implemented method and a processing device for controlling a vehicle function. The invention moreover relates to a computer program for executing a method of this type, when the computer program is run on a processing device, and to a computer-readable storage medium having a computer program of this type. In particular, the invention relates to the technical field of distraction detection in the context of automated driving functions.

A vehicle function which is to be controlled can be, for example, a warning function and/or a function associated with an automated driving system including, e.g., a driver-assistance system (DAS). In the context of the present document, the term “automated driving” or “automated driving function” is to be understood as driving with automated longitudinal and/or lateral control. Automated driving can involve, for example, prolonged driving on a motorway or short-term driving in the context of parking. The term “automated driving” encompasses automated driving with an arbitrary degree of automation. Exemplary degrees of automation are assisted, partially automated, conditional automated, highly automated and fully automated driving (respectively associated with an increasing degree of automation). The above-mentioned five degrees of automation correspond to SAE Levels 1 to 5, according to SAE Standard J3016 (SAE: Society of Automotive Engineering), in the version in force on Apr. 30, 2021. In the case of assisted driving (SAE Level 1), the system executes longitudinal or lateral control in specific driving situations, with the expectation that the driver will assume all other aspects of dynamic driving functions. In the case of partially automated driving (SAE Level 2), the system assumes longitudinal and lateral control in specific driving situations, wherein the driver is required to monitor the system continuously, as in the case of assisted driving. In the case of conditional automated driving (SAE Level 3), the system assumes longitudinal and lateral control in specific driving situations, without the necessity for continuous monitoring of the system by the driver; however, the driver must be in a situation in which, at the request of the system, they are capable of assuming control of the vehicle within a specific time interval. In the case of highly automated driving (SAE Level 4), the system assumes control of the vehicle in specific driving situations, even in the absence of a response by the driver to a request for intervention, such that the driver is not required as a fallback level. In the case of fully automated driving (SAE Level 5), the system can assume all aspects of the dynamic driving function under any carriageway conditions and ambient conditions, which aspects can also be managed by a human driver.

State-of-the-art passenger motor vehicles frequently incorporate a fatigue or attentiveness detection function, which enables states of the driver to be detected in which the driver is fatigued and/or inattentive. For example, driver fatigue can be detected by means of a driver camera which is arranged in the interior of the vehicle, by reference to an eye-blinking pattern of the driver. Moreover, inattentive states on the part of the driver in which, for example, the latter is not looking forwards in the direction of the highway, but sideways through a window, can be detected by means of the driver camera. In the event that such driver fatigue and/or inattentiveness is detected, for example, a visual or acoustic warning instruction can then be output for the attention of the driver. Alternatively or additionally, for example, driving operation parameters of a system for automated driving can be modified, for example, in the form of a downrating of a driver-assistance function, in conjunction with a request for takeover by the driver. In the event of the detection of driver fatigue, a proposal for taking a coffee break can be directed to the driver, for example.

One potential type of distraction, which can divert the attention of the driver from traffic conditions, is the conduct of a telephone conversation during travel. In this connection, DE 10 2018 200 381 A1 discloses a method for the situation-dependent adaptation of a motor vehicle wherein, by reference to an active employment of a hands-free device of the motor vehicle, by means of a microphone of the motor vehicle and/or by means of a camera of the motor vehicle, detection is executed to the effect that the driver is using the telephone.

In solutions of this type which are known from the prior art, however, a problem arises in that, although it can be detected whether (and, potentially, for what duration) the driver is using the telephone, the extent to which the driver is cognitively distracted as a result and, in consequence, has a restricted attentiveness to vehicle control and traffic conditions cannot be detected.

One object of the present invention is the disclosure of a method and a processing device which enable an improved detection of a cognitive distraction of a driver of a vehicle associated with the conduct of a telephone conversation during travel.

This object is fulfilled by the subject matter of the independent patent claims. Advantageous embodiments are disclosed in the dependent claims.

It is hereby observed that additional features of a patent claim which is dependent upon an independent patent claim, in the absence of the features of the independent patent claim, or in combination with only a subset of the features of the independent patent claim can constitute a standalone invention, which is independent of the combination of all the features of the independent patent claim, and which can form the subject matter of an independent patent claim, a divisional application or a subsequent application. The same applies, in an equivalent manner, to the technical instruction which is explained in the description, which technical instruction can also form an invention which is independent of the features of the independent patent claims.

A first aspect of the invention relates to a computer-implemented method for controlling a vehicle function such as a driver-assistance function, and/or a warning function of a vehicle.

The vehicle can be a motor vehicle. In particular, the term “motor vehicle” is understood as a terrestrial vehicle which is moved by mechanical force, and which is not rail-mounted. A motor vehicle according to this definition can be configured, e.g., as a motor car, a motorcycle or a tractor.

One step of the method is the reception of speech indicator information, which information comprises indications as to whether a driver of the vehicle is conducting a telephone conversation. The term “telephone conversation” is to be understood in a broad sense, and includes, e.g., a conversation with an interlocutor who is situated outside the vehicle which is conducted via a cellular radio network or an Internet-based service such as, for example, WhatsApp, Microsoft Teams, Skype or similar.

In a further step of the method, according to speech indicator information, it is determined that the driver is conducting a telephone conversation. Establishment to the effect that the driver is conducting a telephone conversation can be executed based on an evaluation logic, according to which available elements of speech indicator information (optionally in the form of a combination of multiple different types of speech indicator information) are analyzed. It is also possible that artificial intelligence methods such as a classification algorithm, which is based upon an artificial neural network, are employed.

A further step is the reception of speech intensity information, which information comprises indications of the extent to which the driver is engrossed in the telephone conversation. It should be observed that speech intensity information, according to individual embodiments, can be partially or entirely identical to speech indicator information. In the event that speech intensity information and speech indicator information are identical, the step for the reception of speech intensity information, in the form of a separate step, can be omitted.

In a further step of the method, according to the speech intensity information, a degree of attentiveness to the telephone conversation which is evinced by the driver is ascertained.

The degree of attentiveness provides an insight into the extent to which the driver is engrossed in the telephone conversation. If a driver of a vehicle is engrossed in a telephone conversation, they will have a tendency to exhibit a more limited perception of circumstances which are relevant to vehicle control, including, e.g., other road users. It can occur that the driver continues to look forwards onto the highway, such that no perceptible visual distraction is in force; in such a situation, the driver can nevertheless be engrossed in a telephone conversation to the extent that they are no longer fully mentally conscious of traffic conditions. It can thus be assumed that the degree of attentiveness of the driver to the telephone conversation correlates to a degree of cognitive distraction of the driver from the functions thereof which are associated with vehicle control.

Ascertainment of the degree of attentiveness can be executed based on an evaluation logic, according to which available elements of speech intensity information (optionally in the form of a combination of multiple different types of speech indicator information) are analyzed. It is also possible that artificial intelligence methods such as a classification algorithm, which is based upon an artificial neural network, are employed.

In a further step of the method, according to the degree of attentiveness ascertained, a control signal for a vehicle function of the vehicle is generated.

A second inventive aspect is a (data) processing device which comprises at least one processor, and which is designed for executing a computer-implemented method according to the first inventive aspect, by means of the processor. Embodiments of the method according to the invention can correspond to embodiments of the processing device according to the invention described in the present document, and vice versa.

The processing device can comprise one or more processors, such as microcontrollers, which are designed for executing the method by means of a computer program. According to some embodiments, a spatially distributed processing device (e.g., comprised of multiple and mutually separated processors or microcontrollers) can also be employed.

For example, the processing device can be a control device or an element of a control device of the vehicle, in particular a control device for controlling the vehicle function, such as an automated driving function.

According to some embodiments, speech indicator information and/or speech intensity information comprise image capture data with respect to the vehicle interior including, e.g., data with respect to the driver and/or with respect to further passengers who are present in the vehicle interior. Image capture data, in a manner which is known per se, can, for example, have been captured by means of one or more interior cameras, in the form of moving or still digital images.

According to one variant of embodiment, it is provided that, e.g., by reference to image capture data, it is detected that the driver is wearing a headset, and that this circumstance is considered in the determination as to whether the driver is conducting a telephone conversation. The term “headset” is understood to include all conventional types of headsets, including wireless or hard-wired on-ear headsets and in-ear headsets.

Image capture data, which enable detection to the effect that the driver is wearing a headset, can be employed as speech indicator information, wherein these data provide an indicator to the effect that the driver is conducting a telephone conversation. By means of conventional distraction detection methods, a distraction of the driver associated with the employment of wireless or hard-wired headsets cannot be easily detected, as telephoning devices of this type—conversely, for example, to a hands-free device which is integrated in the vehicle—are not necessarily actively connected to the vehicle. Accordingly, it cannot be directly ascertained, by means of a vehicle bus system, whether (and, optionally, for what duration) the driver is conducting a telephone conversation which might impair their attentiveness to vehicle control. By means of a direct camera-based capture of a headset on the head of the driver, an active telephone conversation can be detected, even in cases in which communication is executed independently of vehicle systems (e.g., by the employment of a mobile telephone which is connected to the headset), and employed as an indicator for distraction detection.

According to a further variant of embodiment, it can be provided that, rather than a headset, a portable terminal is detected which is held in the hand of the driver (particularly at the ear, or in proximity to the mouth). For example, it can be ascertained from an evaluation of image capture data that the driver is holding a smartphone in their hand, in proximity to their head. In a case of this type, corresponding image capture data are also speech indicator information which indicate that the driver is conducting a telephone conversation.

According to one embodiment, by reference to image capture data, mouth movements (including lip movements) of the driver and/or of further occupants of the vehicle are detected, which movements are considered in the determination of whether the driver is conducting a telephone conversation and/or in the ascertainment of the degree of attentiveness of the driver vis-à-vis the telephone conversation. In other words, an active conversation of the driver and/or of further occupants of the vehicle can thus be detected in a camera-based manner. Speech can be distinguished from singing by the analysis of lip dynamics, particularly by reference to rhythmic and recurrent lip movements. The circumstance whereby the driver is engaged in active speech can thus be evaluated as a positive or negative indicator of a distraction of the driver by a telephone conversation. For example, prolonged active speech on the part of the driver, which is not interrupted by an active speech phase on the part of one or more further occupants of the vehicle, is indicative of an engrossment of the driver in a telephone conversation. Conversely, if active speech phases on the part of the driver and on the part of one or more further occupants of the vehicle proceed in an alternating manner, this can be interpreted as an indication of a conversation between vehicle occupants—as distinct from a telephone conversation. Image capture data, from which mouth movements of the driver and/or of further occupants of the vehicle are identified, can thus be employed as meaningful speech indicator information. However, it is also conceivable that image capture data of this type are employed as speech intensity information in the context of the method proposed herein. For example, from mouth or lip movements of the driver, a conclusion can be inferred with respect to an intensity of the conversation, and thus with respect to the degree of attentiveness of the driver to the telephone conversation.

Alternatively or additionally, it can be provided that, by reference to image capture data, gesticulations and/or facial expressions of the driver and/or of further occupants of the vehicle are detected and considered in the determination as to whether the driver is conducting a telephone conversation and/or in the ascertainment of the degree of attentiveness of the driver vis-à-vis the telephone conversation. For example, from gesticulations and/or facial expressions of the driver, an intensity of a telephone conversation can be inferred and, in turn, a conclusion of the degree of intensiveness is enabled. Thus, for example, extravagant gesticulation by the driver can be indicative of a high level of emotional engagement, and thus of an associated high degree of attentiveness on the part of the driver to the telephone conversation. In consequence, image capture data, from which a gesticulation and/or facial expression of the driver can be inferred, can particularly be employed by way of speech intensity information. However, it is also conceivable that a highly pronounced gesticulation and/or facial expression on the part of one or more further occupants of the vehicle, which corresponds to a gesticulation and/or facial expression of the driver, can be interpreted as an indicator to the effect that an intensive conversation between occupants of the vehicle is in progress—as distinct from a telephone conversation. Accordingly, image capture data of this type can also be employed as speech indicator information which, in the present example, would deliver an indicator to the effect that the driver is not conducting a telephone conversation.

In general, in the context of the present method, a confirmed presence or absence of further occupants of the vehicle can be considered in the determination as to whether the driver is conducting a telephone conversation and/or in the ascertainment of the degree of attentiveness of the driver vis-à-vis a telephone conversation. Primarily, this applies independently of the manner in which the presence or absence of further occupants of the vehicle is sensorially established. In this context, in addition to the above-mentioned optical capture of further occupants of the vehicle, an acoustic capture of noise, in particular of speech, generated by further occupants of the vehicle is also conceivable, by means of one or more microphones which are arranged in the interior of the vehicle. A further option is the employment of a seat occupancy detection function which, in a manner which is known per se, can be based e.g. upon a seat mat and/or a seatbelt buckle sensor. Information with respect to the presence or absence of further occupants of the vehicle and, optionally, with respect to characteristics and/or a behavior of one or more further occupants of the vehicle, can assist in the distinction as to whether the driver is in conversation with one or more occupants of the vehicle, or is conducting a telephone conversation. Information of this type can thus be employed, in particular, as speech indicator information. In the event that, for example, the presence of a child on the rear seat of the vehicle is detected, a case discrimination can thus be executed as to whether the child is detected as sleeping or waking, and whether, correspondingly, the child is a potential interlocutor of the driver, or otherwise. A child who is detected as sleeping would not be classified as a potential interlocutor of the driver. In the event that, additionally to the driver and the sleeping child, no further occupants of the vehicle are present, the circumstance whereby, for example, the driver is wearing a headset and is engaged in active speech over a prolonged period, might thus be interpreted as an indicator of an active telephone conversation on the part of the driver.

However, scenarios are also conceivable in which the driver assumes only a limited proportion, or no proportion of active speaking in a telephone conversation, on the grounds that e.g. their interlocutor is speaking for the majority of the time. Even in situations of this type, the driver can be deeply cognitively engrossed in the conversation and, in consequence, devotes only insufficient attentiveness to driving conditions. According to a number of configurations of the invention described hereinafter, in such situations of a predominantly passive involvement in conversation, a high degree of attentiveness of the driver vis-à-vis the telephone conversation can also be ascertained.

For example, by reference to image capture data, an eye tracking sequence of the driver can be determined and considered in the ascertainment of the degree of attentiveness of the driver vis-à-vis the telephone conversation. Ascertainment of the eye tracking sequence can be executed e.g. according to a method proposed in German patent application n° 10 2022 103 912 for monitoring a status of a driver of a vehicle, by means of a camera in the interior of the vehicle. The content of this previous patent application of the applicant is thus included, in full, in the scope of the present document. In accordance with an exemplary embodiment described therein—with reference to the present context—a cognitive distraction, from their driving function, of a driver who is engrossed in a telephone conversation can be detected e.g. wherein a captured eye tracking sequence of the driver deviates from a target eye tracking sequence, which is appropriate to the active driving situation, by a specific degree. The target eye tracking sequence can comprise, for example, a regulation sequence of visual checks on the part of the driver. For example, the target eye tracking sequence can comprise a regulation sequence of visual checks of an interior mirror, of one or more exterior mirrors, of a speedometer, through a windshield, over the shoulder, and/or through one or more side windows of the vehicle. In the context of the method proposed herein, image capture data incorporating information on an eye tracking sequence of the driver of this type can thus be employed as speech intensity information.

Alternatively or additionally to an eye tracking sequence, by reference to image capture data, a statistical volatility of a viewing direction of the driver can also be ascertained and considered in the ascertainment of the degree of attentiveness of the driver vis-à-vis the telephone conversation. In particular, a method described in German patent application n° 10 2022 115 531 for determining an attentiveness of a user of a motor vehicle can be employed. The content of this previous patent application of the applicant is thus included, in full, in the scope of the present document. The method proposed in this previous patent application is based upon the finding to the effect that the vision of a highly attentive driver of a vehicle is predominantly focused on traffic conditions outside the motor vehicle. The vision of the driver thus alternates, in comparatively short time intervals, between different points, for example to the front, to the side, into a rear-view mirror and/or towards an in-vehicle display. Conversely, in the case of a cognitively distracted and/or fatigued driver, i.e., a driver having limited attentiveness, vision is focused on a single point, or within a comparatively narrow range. This means that the scatter, for example of the viewing direction and/or of pupil movements declines, which decline can be established, e.g., by a statistical evaluation of viewing information of the user at different time points, and by a determination of a mean deviation of viewing information about a mean value. This phenomenon of a “fixed stare” can be employed for ascertaining a cognitive distraction or attentiveness of a driver who is cognitively engrossed in a telephone conversation, and thus only “stares straight ahead”.

According to a further embodiment, speech indicator information and/or speech intensity information—alternatively or additionally to the above-mentioned image capture data—can comprise sound capture data with respect to the interior of the vehicle. Sound capture data can have been captured by means of one or more microphones which are arranged in the interior of the vehicle. Sound capture data can comprise noise, in particular speech, which is generated by the driver and/or by one or more further occupants of the vehicle. The circumstance, thus ascertained by acoustic means, to the effect that the driver is actively speaking (optionally including a duration of speech, a frequency or intensity of speech and/or a potential conversational interaction with further occupants of the vehicle) can thus be employed, in an analogous manner, for determining that the driver is conducting a telephone conversation and/or for ascertaining a degree of attentiveness of the driver vis-à-vis the telephone conversation, as described above with reference to circumstances which are detected by reference to image capture data.

It is further included within the scope of the invention that, by reference to image capture data and/or sound capture data, an emotional state of the driver is ascertained, which state is considered in the ascertainment of the degree of attentiveness of the driver vis-à-vis a telephone conversation. In the case of image capture data (by way of speech intensity information), this can be executed, e.g., by the employment of detection algorithms for optical facial expression classification which are known per se, in particular according to the Facial Action Coding System (FACS). In the case of acoustically captured speech intensity information (sound capture data), an emotionally excited state of the driver and/or of a further occupant of the vehicle can be ascertained, for example, by reference to a frequency and/or by reference to the tone content or pitch of speech thus captured. An emotionally excited state of the driver can be interpreted e.g. as an indicator to the effect that the driver is devoting a high degree of attentiveness to a telephone conversation which is currently in progress.

According to one embodiment, it is provided that a duration of the telephone conversation (thus far) is ascertained, which duration is considered in the ascertainment of the degree of attentiveness of the driver vis-à-vis the telephone conversation. For example, the duration of the telephone conversation can be ascertained by reference to information which is supplied by a hands-free device which is integrated in the vehicle, or by the controller thereof. Alternatively or additionally, this duration can be determined visually (e.g., by reference to lip movements of the driver) and/or acoustically (by reference to speech of the driver which is captured by means of microphones). It is conceivable, e.g., that a time measurement for determining the duration of the telephone conversation is initiated, immediately it has been established that the driver is conducting a telephone conversation. With respect to this duration, e.g. a threshold value can be provided, upon the overshoot of which a high degree of attentiveness of the driver vis-à-vis the telephone conversation is assumed. In the event that, e.g., the driver is on the telephone for at least 10 minutes, according to some embodiments, this can be interpreted as an indicator of a distraction from driving. This is based upon the concept whereby the mental concentration of the driver can be gradually transferred to the telephone conversation. According to a number of variants of embodiments, this concept can be supported by further above-mentioned criteria, such as the assumption of a “fixed stare” or the occurrence of an emotionally excited state. In general, it can be provided that, in the context of the method proposed herein, it is detected whether the concentration of the driver is gradually being transferred to the telephone conversation.

It is further included within the scope of the invention that ascertainment of the degree of attentiveness of the driver vis-à-vis the telephone conversation comprises an ascertainment of a numerical attentiveness value which is characteristic of the degree of attentiveness. The attentiveness value can thus be compared with a predetermined threshold value, and the control signal can be generated in accordance with an outcome of this comparison. It can be provided that a control signal is generated in the event that the attentiveness value overshoots or undershoots the threshold value (depending upon the definition of the attentiveness value). In general terms, the generation of a control signal for a vehicle function, according to the degree of attentiveness ascertained, can thus comprise a threshold value comparison. It is also conceivable that the threshold value for triggering a control signal, and, e.g., for triggering a warning message for the attention of the driver, is modified in response to specifically detected circumstances. For example, factors such as the detection of a pronounced gesticulation or a raised volume of speech of the driver, which are indicative of a high level of emotional engagement in the telephone conversation, can be employed for lowering the threshold value for triggering a control signal.

As mentioned above, the control signal generated can be, for example, a control signal for triggering a warning which is directed at the driver, in order to alert the driver to a potential hazard. For example, it can be provided that the warning is executed in the form of an acoustic output which intervenes directly in the conversation. This is particularly an option in the event that, by means of an on-board communication system or an app, direct access to a hands-free device or to a smartphone which is employed by the driver is enabled.

Alternatively or additionally to the output of a dedicated warning signal, it can be provided that the control signal is a control signal for adjusting (in particular, for increasing) an intensity of a signal output in the vehicle. For example, acoustic navigation instructions, or signals and instructions which are output in the context of a driver-assistance system (such as e.g. a visual display or an acoustic warning bell tone in the event of an overshoot of a speed limit, in the context of a “Speed Limit Information” function) can be amplified in intensity by the control signal. In general, an adjustment of signal outputs of this type can be executed in a visual, acoustic and/or haptic manner. One example of a haptic warning is the vibration of the steering wheel, which is frequently employed in conjunction with a lane departure warning system.

According to one embodiment, the control signal comprises a control signal for an automated driving function. In particular, the control signal can initiate a modification of an operating parameter of an automated driving function, such as a driver-assistance function. The automated driving function, e.g., can thus be sensitized in the event that it has been ascertained that the degree of attentiveness of the driver to the telephone conversation is high and, correspondingly, it must be assumed herefrom that the driver is only directing a reduced attentiveness towards driving. For example, it can be provided that, in the case of a blind spot assist function, a lane-keeping assist function or a lane departure warning function, a trigger threshold for a warning signal is reduced, or a compensating pulse in the form of a steering torque is amplified. Moreover, in the case of a collision warning function or an emergency brake assist function, a respective trigger distance can be increased. In the case of a combined speed and distance control function (adaptive cruise control, or ACC), a distance to the vehicle ahead can be automatically expanded, to increase the response time which is available to the driver, if necessary.

A third inventive aspect is a system for controlling a vehicle function of a vehicle.

The system comprises one or more capture devices for capturing speech indicator information, which information comprises indications as to whether the driver of the vehicle is conducting a telephone conversation, and for capturing speech intensity information, which information comprises indications of the extent to which the driver is engrossed in a telephone conversation.

With respect to potential types of speech indicator information and speech intensity information, reference may be made to the preceding descriptions of the first and second inventive aspects. Correspondingly, by way of a capture device of the system, for example, an interior camera and/or a microphone can be provided. However, it is also possible for a hands-free device which is integrated in the vehicle, or the controller thereof, to be employed as a capture device for speech indicator information and/or speech intensity information, which capture device supplies information with respect to an active telephone call and/or with respect to the duration thereof thus far.

The system further comprises a processing device which is designed for executing a method according to the first inventive aspect. In particular, the processing device of the system is thus designed, in accordance with speech indicator information, to determine that the driver is conducting a telephone conversation, in accordance with speech intensity information, to ascertain a degree of attentiveness of the driver vis-à-vis the telephone conversation and, in accordance with the degree of attentiveness ascertained, to generate a control signal for a vehicle function of the vehicle.

A fourth inventive aspect is a non-transitory computer-readable medium storing a program comprising commands which, upon the execution of the computer program by a processing device, initiate the execution by the latter of a method according to the first inventive aspect. The computer program can be subdivided into multiple separate subprograms, which subprograms can be respectively executed on different and, optionally, mutually spatially separated processing devices (e.g., multiple separate processors).

A processing device according to the second or third inventive aspect can be designed (programmed) to execute the computer program according to the fourth inventive aspect.

A fifth inventive aspect is a computer-readable storage medium, comprising commands which, upon the execution thereof by an (optionally distributed) processing device, initiate the execution by the latter of a method according to the first inventive aspect. In other words, a computer program according to the fourth inventive aspect can thus be saved on the computer-readable storage medium.

A sixth inventive aspect is a vehicle, in particular a motor vehicle, having a processing device according to the second inventive aspect, or having a system according to the third inventive aspect.

According to a development, the vehicle can further comprise an output device for an (e.g., visual, acoustic and/or haptic) warning or signal output, which output device is actuatable by means of the control signal. Alternatively or additionally, the vehicle can comprise a system for automated driving, such as e.g. a driver-assistance system, which system is controllable by means of the control signal generated, wherein, e.g., an operating parameter of an automated driving function is modified in accordance with the control signal.

The invention is described in greater detail hereinafter with respect to exemplary embodiments, and with reference to the attached drawings. Features and combinations of features specified heretofore or hereinafter in the description, and/or represented in the drawings alone, are not only applicable in the respectively indicated combination, but also in other combinations, or in isolation, without departing from the scope of the invention.

### BRIEF DESCRIPTION OF THE DRAWINGS

FIG. 1 shows an exemplary and schematic illustration of a system for controlling a vehicle function;

FIG. 2 shows an exemplary and schematic illustration of steps of a method for controlling a vehicle function.

### DETAILED DESCRIPTION OF THE DRAWINGS

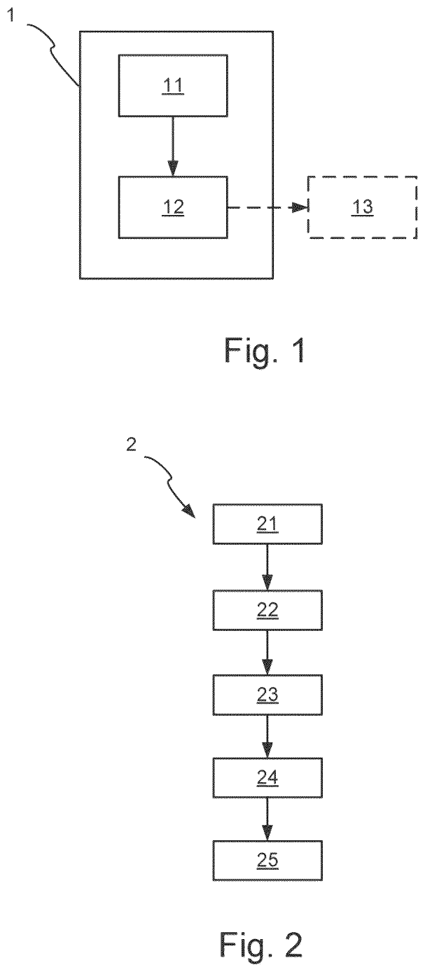

The schematically represented system 1 according to FIG. 1 for controlling a vehicle function is described hereinafter with reference to the steps 21-25 of a method 2 for controlling a vehicle function which are illustrated in FIG. 2 in the form of a block diagram.

The system 1 comprises a capture device 11 which is designed for capturing speech indicator information and speech intensity information. Although in FIG. 1, exemplarily, only one capture device 11 is illustrated, multiple capture devices can be provided.

For example, one or more interior cameras and/or one or more microphones, which are arranged in the vehicle interior, can be employed as capture devices 11. Correspondingly, speech indicator information captured can comprise image capture data and/or sound capture data, which data provide indicators as to whether a driver of the vehicle is conducting a telephone conversation. Likewise, speech intensity information can comprise image capture data and/or sound capture data, which data provide indicators of the extent to which the driver is engrossed in a telephone conversation. Under certain circumstances, speech indicator information and speech intensity information can also be entirely or partially identical.

The system 1 further comprises a (data) processing device 12. The processing device 12 comprises one or more processors, and is programmed for executing the process steps 21-25 according to FIG. 2.

In one process step 21, the processing device 12 receives speech indicator information which are captured by means of the capture device 11. To this end, the processing device 12 is connected to the capture device 11 by means of a data transmission link.

In a further process step 22, the processing device 12, based on speech indicator information received, determines that the driver of the vehicle is presently conducting a telephone conversation.

According to one exemplary scenario, the processing device 12, by reference to image capture data which are captured by means of a driver camera 11, detects that the driver is wearing a headset. The headset can be connected, e.g., wirelessly, to a smartphone of the driver which is carried in the vehicle. The driver can thus initiate a call by means of the headset and the smartphone. This call can be detected by the processing device 12, e.g., from optically captured mouth movements and/or from speech sounds of the driver which are captured by means of one or more microphones 11.

Further circumstances which are included in speech indicator information can be involved in the determination of the processing device 12 to the effect that the driver is probably conducting a telephone conversation. For example, by reference to a seat occupancy detection function and/or by means of a seatbelt buckle sensor, it can be detected that a passenger is present in the vehicle who might be a potential interlocutor of the driver; however, the processing device 12, e.g., by reference to image capture data, is able to detect that the passenger is not executing any lip movements which are indicative of speech. In this case, captured speech indicator information, in its overall combination, is indicative of the fact that the driver is actually conducting a telephone conversation. The same applies to a situation in which, e.g., a child is detected on a rear seat and in which, however, it is further detected that the child is sleeping and, consequently, is likewise not a potential interlocutor of the driver. In particular, the processing device 12 can thus execute a distinction as to whether the driver is engaged in direct conversation with further occupants of the vehicle, or is conducting a telephone conversation.

In conclusion, in consideration of multiple speech indicator information of this type, the processing device 12, in accordance with an evaluation logic and, under certain circumstances, by the employment of artificial intelligence methods, such as neural networks, determines that the driver of the vehicle is (probably) conducting a telephone conversation.

In a further process step 23, the processing device 12 receives speech intensity information from the capture device 11.

For the reception of speech intensity information, a separate step for the transmission of information from the capture device 11 to the processing device 12 is not always necessary. Instead, for example, in image capture data and/or sound capture data which are supplied to the processing device 12 by one or more capture devices 11, both speech indicator information and speech intensity information can be included. As mentioned above, under certain circumstances, speech intensity information can also be entirely or partially identical to speech indicator information. Accordingly, in a number of embodiments, step 23 for the reception of speech intensity information can be omitted as a separate process step.

In a further process step 24, the processing device 12 employs speech intensity information for the ascertainment, on the basis thereof, of a degree of attentiveness of the driver vis-à-vis the telephone conversation.

For example, the processing device 12 can be designed to determine a duration of the telephone conversation thus far, and to consider this duration in the ascertainment of the degree of attentiveness. With respect to the above-mentioned exemplary situation, the processing device, e.g., by reference to image capture data, can establish that the driver has been executing lip movements for longer than 10 minutes, which duration is indicative of a continuous telephone conversation. In the context of the determination 24 of the degree of attentiveness, this can be interpreted as an indicator to the effect that the concentration of the driver has already been substantially transferred to the telephone conversation.

Additionally, further circumstances which are included in speech intensity information, or which can be inferred herefrom, can be taken into consideration. The processing device 12 can thus be designed, by reference to image capture data and/or sound capture data, to identify an emotionally excited state of the driver. This can be executed, for example, by the employment of detection algorithms for optical facial expression classification (FACS) which are known per se, or by reference to an analysis of a frequency and/or pitch of the speech of the driver. An emotionally excited state can also be determined, e.g., by reference to a facial expression and/or gesticulation of the driver. In the event that an emotionally excited state of the driver is identified, this can further support the assumption of an increased degree of attentiveness of the driver vis-à-vis the telephone conversation.

Even in the event that the driver themselves is not speaking for a prolonged period, they can nevertheless be engrossed in a telephone conversation in which their interlocutor is predominantly speaking. In order to take account of such situations, for example, by reference to image capture data, an eye tracking sequence of the driver and/or a statistical volatility of a viewing direction of the driver can be analyzed. In the event that the driver deviates from an eye tracking sequence which is anticipated for a specific active driving situation (e.g., a sequence of visual checks of interior mirrors, exterior mirrors or side windows), this can be interpreted as an indicator to the effect that the driver is distracted from driving by the telephone conversation. Likewise, e.g., by reference to a “fixed stare” of the driver, in which the viewing direction thereof assumes a noticeably limited scatter about a mean value, it can be concluded that the driver is cognitively engrossed in the telephone conversation.

The processing device 12 can be designed, from speech intensity information, to infer multiple factors of the above-mentioned type, and to execute the combination thereof in accordance with an evaluation logic, in order to ascertain the degree of attentiveness of the driver vis-à-vis the telephone conversation. The employment of artificial intelligence, including, e.g., the employment of neural networks, is also possible.

For example, the processing device 12 can ascertain a numerical attentiveness value which is characteristic of the degree of attentiveness.

In a further process step 25, the processing device 12 generates one or more control signals for a driving function of the vehicle. The control signal(s) is (are) generated in accordance with the degree of attentiveness of the driver ascertained vis-à-vis the telephone conversation.

For example, a numerical attentiveness value, which is characteristic of the degree of attentiveness, can be compared with a predetermined threshold value, and the one or more control signals can be generated in accordance with an outcome of the comparison. In particular, it can be provided that a control signal is generated for outputting a warning message for the attention of the driver, in the event that the attentiveness value exceeds the threshold value.

Alternatively or additionally to the output of a warning message, one or more control signals can also be generated for the modification of an operating parameter of an automated driving function. Thus, e.g., a sensitivity of a blind spot assist function can be increased to the extent that a warning is output earlier, and/or with a more intensive warning signal, in the event that the attentiveness value exceeds the threshold value. In the case of adaptive cruise control (ACC), it can be provided, e.g., that a distance to the vehicle ahead is increased.

In FIG. 1, the schematic block 13 represents a device which is arranged down-circuit of the system 1, which device is actuatable by means of control signals which are generated by the processing device 12. The down-circuit device 13, in accordance with the exemplary embodiments described above can be, for example, an output device 13 which is arranged in the vehicle, for outputting a warning message for the attention of the driver. Alternatively or additionally, the down-circuit device 13 can be a driver-assistance system, the operating parameters of which are modifiable in accordance with the control signal.

1.-13. (canceled)

14. A computer-implemented method for controlling a vehicle function of a vehicle, the method comprising:
receiving speech indicator information including an indication as to whether a driver of the vehicle is conducting a telephone conversation;
determining, by reference to the speech indicator information, whether the driver is conducting the telephone conversation;
receiving speech intensity information including an indication of the extent to which the driver is engrossed in the telephone conversation;
determining a degree of attentiveness of the driver vis-à-vis the telephone conversation, based on speech intensity information; and
generating a control signal for a vehicle function of the vehicle based on the degree of attentiveness.

15. A processing device comprising at least one processor configured to execute a method according to claim 14.

16. The processing device according to claim 15, wherein at least one of the speech indicator information and the speech intensity information includes image capture data with respect to a vehicle interior.

17. The processing device according to claim 16, wherein the processing device is configured to detect, by reference to the image capture data, that the driver is wearing a headset, and to consider such a detection in the determination as to whether the driver is conducting the telephone conversation.

18. The processing device according to claim 16, wherein the processing device is configured, by reference to the image capture data, to detect at least one of a gesticulation, a facial expression, and mouth movements of at least one of the driver and other occupants of the vehicle, and to execute the consideration thereof in at least one of a determination as to whether the driver is conducting the telephone conversation and a determination of the degree of attentiveness.

19. The processing device according to claim 17, wherein the processing device is configured, by reference to the image capture data, to detect at least one of a gesticulation, a facial expression, and mouth movements of at least one of the driver and other occupants of the vehicle, and to determine at least one of whether the driver is conducting the telephone conversation and a determination of the degree of attentiveness based on the at least one of the gesticulation, the facial expression and the mouth movements.

20. The processing device according to claim 16, wherein the processing device is configured, by reference to the image capture data, to determine at least one of an eye tracking sequence of the driver and a volatility of a viewing direction of the driver, and to determine the degree of attentiveness based on the at least one of the eye tracking sequence and the volatility.

21. The processing device according to claim 17, wherein the processing device is configured, by reference to the image capture data, to determine at least one of an eye tracking sequence of the driver and a volatility of a viewing direction of the driver, and to determine the degree of attentiveness based on the at least one of the eye tracking sequence and the volatility.

22. The processing device according to claim 18, wherein the processing device is configured, by reference to the image capture data, to determine at least one of an eye tracking sequence of the driver and a volatility of a viewing direction of the driver, and to determine the degree of attentiveness based on the at least one of the eye tracking sequence and the volatility.

23. The processing device according to claim 15, wherein at least one of the speech indicator information and the speech intensity information includes sound capture data with respect to an interior of the vehicle.

24. The processing device according to claim 16, wherein at least one of the speech indicator information and the speech intensity information includes sound capture data with respect to an interior of the vehicle.

25. The processing device according to claim 17, wherein at least one of the speech indicator information and the speech intensity information includes sound capture data with respect to an interior of the vehicle.

26. The processing device according to claim 15, wherein the processing device is configured, by reference to at least one of image capture data and sound capture data, to ascertain an emotional state of the driver, and to determine the degree of attentiveness based on the at least one of the image capture data and the sound capture data.

27. The processing device according to claim 16, wherein the processing device is configured, by reference to at least one of the image capture data and sound capture data, to ascertain an emotional state of the driver, and to determine the degree of attentiveness based on the at least one of the image capture data and the sound capture data.

28. The processing device according to claim 15, wherein the processing device is configured to determine a duration of the telephone conversation, and to determine the degree of attentiveness based on the duration.

29. The processing device according to claim 15, wherein the processing device is configured to determine a numerical attentiveness value which is characteristic of the degree of attentiveness, to compare the attentiveness value with a threshold value, and to generate the control signal based on an outcome of the comparison.

30. The processing device according to claim 15, wherein the control signal is configured to control at least one of an adjustment of an intensity of a signal output, a triggering of a warning, and an automated driving function.

31. A system for controlling a vehicle function of a vehicle, the system comprising:
one or more capture devices configured to capture:
speech indicator information including an indication as to whether a driver of the vehicle is conducting a telephone conversation; and
speech intensity information including an indication of an extent to which the driver is engrossed in the telephone conversation;
a processing device configured to:
determine that the driver is conducting a telephone conversation, in accordance with speech indicator information;
determine a degree of attentiveness of the driver vis-à-vis the telephone conversation based on speech intensity information; and
generate a control signal for a vehicle function of the vehicle based on the degree of attentiveness.

32. A non-transitory computer-readable medium storing a program comprising commands which, upon execution by a processing device, initiate execution of a method according to claim 14.
